(19) United States
(12) Patent Application Publication
(10) Pub. No.: US 2022/0410892 A1
(43) Pub. Date: Dec. 29, 2022

(54) DRIVING ASSISTANCE DEVICE AND DRIVING ASSISTANCE METHOD

(71) Applicant: Isuzu Motors Limited, Tokyo (JP)

(72) Inventors: Wasantha OSHITA, Fujisawa-shi, Kanagawa (JP); Masaichi TAKAHASHI, Fujisawa-shi, Kanagawa (JP); Shinichiro FUKAZAWA, Fujisawa-shi, Kanagawa (JP)

(73) Assignee: Isuzu Motors Limited, Tokyo (JP)

(21) Appl. No.: 17/801,269

(22) PCT Filed: Feb. 26, 2021
(86) PCT No.: PCT/JP2021/007294

§ 371 Date: Aug. 22, 2022

(30) Foreign Application Priority Data
Feb. 28, 2020 (JP) 2020-033740

(51) Int. Cl. B60W 30/14; B60W 30/16; B60W 30/165

(52) U.S. Cl. CPC B60W 30/146; B60W 30/162; B60W 30/165

(57) ABSTRACT

This driving assistance device includes a target acceleration correcting unit configured as follows: if there was input, from a coupling detection unit, of detection results indicating that a trailer has been coupled, the target acceleration correcting unit outputs a target acceleration, output from an ACC unit, as-is to a drive system; and if there was input of detection results indicating that a trailer (2) has not been coupled, the target acceleration correcting unit corrects to a smaller value the target acceleration, output from the ACC unit, and outputs said corrected target acceleration to the drive system.

### TECHNICAL FIELD

The present disclosure relates to a driving assistance apparatus that assists the driving of a vehicle to which a trailer can be coupled and a driving assistance method of assisting the driving of the vehicle.

### BACKGROUND ART

In recent years, as one technology of assisting the driving of a vehicle, adaptive cruise control (hereinafter referred to as “ACC”) has been gathering attention (for example, see Patent Literature (hereinafter, referred to as PTL 1)). The ACC is a technology of obtaining the vehicle speed of a vehicle, the relative speed of a leading vehicle with respect to the vehicle, the inter-vehicle distance between the vehicle and the leading vehicle, and the like, and controlling a driving system and a braking system of the vehicle such that the vehicle speed and the inter-vehicle distance between the vehicle and the leading vehicle are maintained to be constant.

By applying the technology as above to a vehicle to which a trailer can be coupled such as a so-called tractor, a burden on the operation by a driver of the vehicle can be reduced and the comfortability of the traveling can be improved.

### CITATION LIST

### Patent Literature

PTL 1 Japanese Patent Application Laid-Open No. HEI 7-17295

### SUMMARY OF INVENTION

### Technical Problem

In the case of a tractor that tows a trailer, the vehicle weight greatly changes depending on whether there is a trailer. Therefore, there has been a problem in that values of the actual acceleration and deceleration greatly changes from the originally intended values. As a result, the driving feeling greatly changes depending on whether there is a trailer.

In the case of manual driving, even when the vehicle weight greatly changes, a fluctuation in the acceleration and deceleration due to the fluctuation in the vehicle weight can be suppressed when the driver changes the depression amount of an accelerator or the pedal force on a brake. However, when the ACC is active, such suppression through the driving operation by the driver is difficult.

The present disclosure has been made in view of the points above and provides a driving assistance apparatus and a driving assistance method that may improve the driving feeling when ACC is active in a vehicle to which a trailer can be coupled.

### Solution to Problem

One aspect of a driving assistance apparatus of the present disclosure is an apparatus that assists driving of a vehicle to which a trailer is capable of being coupled, the driving assistance apparatus comprising:

an adaptive cruise control (ACC) section that outputs a target acceleration speed for following a leading car or performing constant speed traveling at a set speed;

a coupling detection section that detects whether a trailer is coupled to the vehicle; and

a target-acceleration-speed correction section that outputs the target acceleration speed to a driving system when a detection result indicating that the trailer is coupled is obtained by the coupling detection section and outputs a corrected target acceleration speed obtained by correcting the target acceleration speed to a small value to the driving system when a detection result indicating that the trailer is not coupled is obtained by the coupling detection section.

One aspect of a driving assistance method of the present disclosure is a method assisting driving of a vehicle to which a trailer is capable of being coupled, the driving assistance method comprising:

outputting a target acceleration speed for following a leading car or performing constant speed traveling at a set speed;

detecting whether a trailer is coupled to the vehicle; and

outputting the target acceleration speed to a driving system when a detection result indicating that the trailer is coupled is obtained and outputting a corrected target acceleration speed obtained by correcting the target acceleration speed to a small value to the driving system when a detection result indicating that the trailer is not coupled is obtained.

### Advantageous Effects of Invention

According to the present disclosure, by outputting the corrected target acceleration speed obtained by correcting the target acceleration speed to a small value to the driving system when it is detected that the trailer is not coupled, a case where the acceleration speed when the trailer is not coupled becomes excessively greater than the originally intended acceleration speed can be suppressed. As a result, the driving feeling when the ACC is active in the vehicle to which the trailer can be coupled may be improved.

### BRIEF DESCRIPTION OF DRAWINGS

FIG. 1 is an external view illustrating an example of a vehicle to which a driving assistance apparatus according to an embodiment is applied;

FIG. 2 is a block diagram illustrating the configuration of the vehicle of the embodiment; and

FIG. 3 is a block diagram illustrating the configuration of the driving assistance apparatus.

### DESCRIPTION OF EMBODIMENTS

One embodiment of the present invention is described in detail below with reference to the accompanying drawings.

<1>Configuration of Vehicle

First, the configuration of a vehicle including a driving assistance apparatus according to one embodiment of the present disclosure is described.

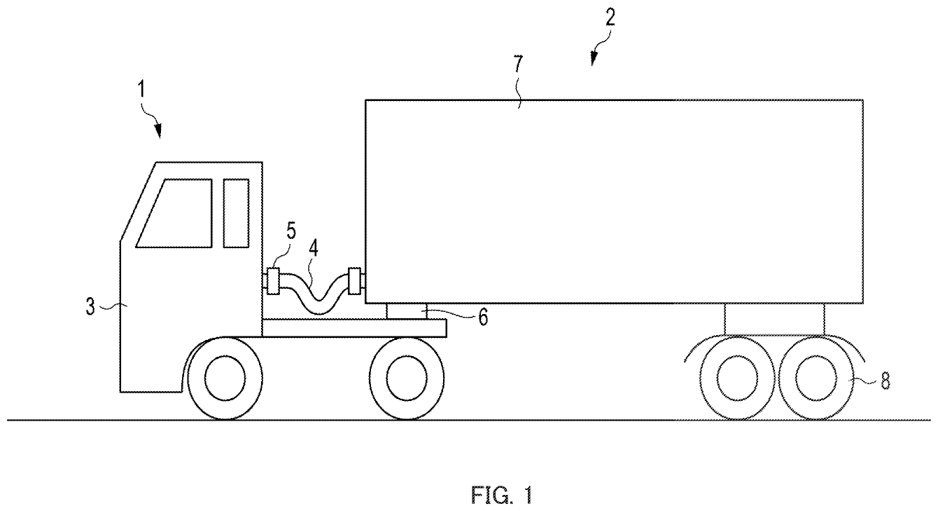

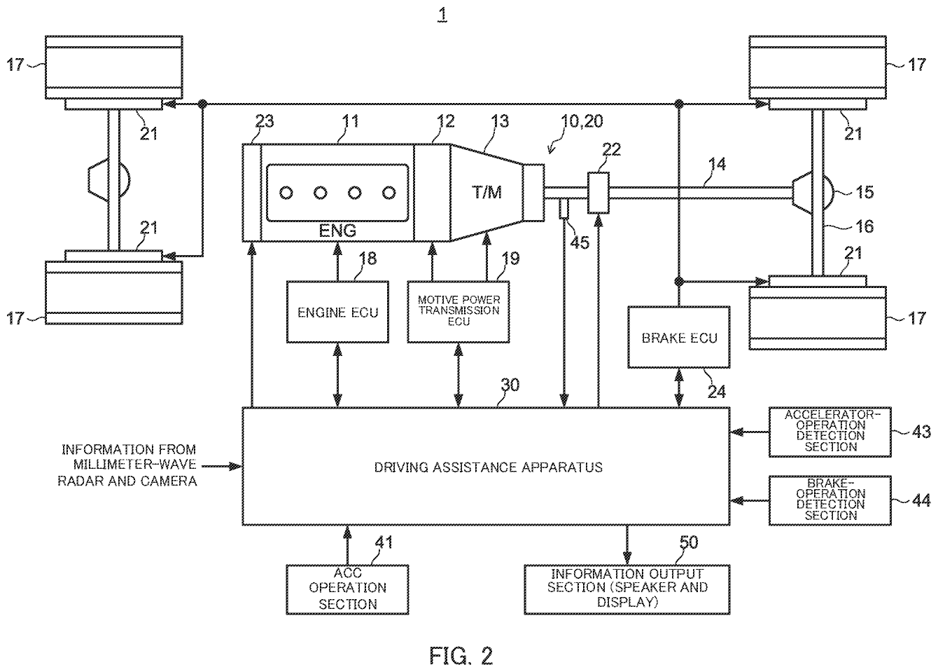

FIG. 1 is an external view illustrating an example of vehicle 1 to which a driving assistance apparatus according to the present embodiment is applied. FIG. 2 is a block diagram illustrating the configuration of vehicle 1. Illustration and description are made by focusing on parts relating to the driving assistance apparatus.

As illustrated in FIG. 1, vehicle 1 is a tractor (traction vehicle) capable of towing trailer 2 as a result of coupling trailer 2 to the tractor.

Vehicle 1 has vehicle main-body portion 3 having a power system such as an engine and driving wheels and a driver's seat, hose 4 and cock 5 for supplying air for brake actuation to trailer 2, and coupler lock switch 6 disposed in a coupling portion with respect to trailer 2. Coupler lock switch 6 is a coupling detection section that detects whether trailer 2 is coupled to vehicle 1. Trailer 2 has loading portion 7 for loading cargo, and trailer wheels 8 that support loading portion 7.

As illustrated in FIG. 2, vehicle 1 has driving system 10 that causes vehicle 1 to travel, braking system 20 that decelerates vehicle 1, driving assistance apparatus 30 that assists the driving of vehicle 1 by a driver, and the like.

Driving system 10 has engine 11, clutch 12, transmission 13, propeller shaft 14, differential gear 15, drive shaft 16, wheels 17, engine ECU 18, and motive power transmission ECU 19.

Engine ECU 18 and motive power transmission ECU 19 are connected to driving assistance apparatus 30 by an in-vehicle network such as a controller area network (CAN) and are able to transmit and receive necessary data and control signals to and from each other. Engine ECU 18 controls the output of engine 11 in accordance with a drive command from driving assistance apparatus 30. Motive power transmission ECU 19 controls the connection and disconnection of clutch 12 and the speed change of transmission 13 in accordance with a drive command from driving assistance apparatus 30.

The motive power of engine 11 is transmitted to transmission 13 via clutch 12. The motive power transmitted to transmission 13 is further transmitted to wheels 17 via propeller shaft 14, differential gear 15, and drive shaft 16. As a result, the motive power of engine 11 is transmitted to wheels 17, and vehicle 1 travels.

Braking system 20 has service brakes 21, auxiliary brakes 22, 23, a parking brake (not shown), and brake ECU 24.

Service brake 21 is a brake that is generally referred to as a main brake, a friction brake, a foot brake, a foundation brake, or the like. Service brake 21 is a drum brake that obtains braking force by pressing a brake lining against the inner side of a drum that rotates with wheel 17, for example.

Auxiliary brake 22 is a retarder (hereinafter referred to as “retarder 22”) that obtains braking force by directly giving load to the rotation of propeller shaft 14, and is an electromagnetic retarder, for example. Auxiliary brake 23 is an exhaust brake (hereinafter referred to as “exhaust brake 23”) that increases an effect of an engine brake with use of rotational resistance of the engine. By providing retarder 22 and exhaust brake 23, the braking force can be increased, and the frequency of usage of service brakes 21 is reduced. Therefore, the wear-out of brake lining and the like can be suppressed.

Brake ECU 24 is connected to driving assistance apparatus 30 by an in-vehicle network such as a CAN and is able to transmit and receive necessary data and control signals to and from each other. Brake ECU 24 controls the braking force of service brakes 21 (the brake fluid pressure of wheel cylinders of wheels 17) in accordance with a braking command from driving assistance apparatus 30.

The braking operation of service brakes 21 is controlled by driving assistance apparatus 30 and brake ECU 24. The braking operation of retarder 22 and exhaust brake 23 is controlled by on/off by driving assistance apparatus 30. The braking force of retarder 22 and exhaust brake 23 is substantially fixed. Therefore, when a desired braking force is to be accurately generated, service brakes 21 that can fine-adjust the braking force are suitable.

Information from a millimeter-wave radar and a camera is input to driving assistance apparatus 30. Information from the millimeter-wave radar and the camera is information indicating the traffic situation and the road situation ahead of the vehicle. Driving assistance apparatus 30 has ACC operation section 41, accelerator-operation detection section 43, brake-operation detection section 44, and the like.

Driving assistance apparatus 30 forms control signals for controlling the operation of driving system 10 and braking system 20. In particular, driving assistance apparatus 30 of the present embodiment obtains a target acceleration/deceleration speed for realizing ACC and a target acceleration speed for realizing CC and outputs the target acceleration/deceleration speed and the target acceleration speed to engine ECU 18, motive power transmission ECU 19, and brake ECU 24, as appropriate. The CC is realized by the ACC as one function of the ACC.

Although not shown, each of engine ECU 18, motive power transmission ECU 19, brake ECU 24, and driving assistance apparatus 30 has a central processing unit (CPU), a storage medium such as a read only memory (ROM) in which a control program is stored, a working memory such as a random access memory (RAM), and a communication circuit, for example. In this case, for example, the functions of sections described below constituting driving assistance apparatus 30 are realized by executing control programs by the CPU. All or some of engine ECU 18, motive power transmission ECU 19, brake ECU 24, and driving assistance apparatus 30 may be integrated.

ACC operation section 41 includes an ACC ON/OFF switch for performing ON/OFF control of the operation of the ACC. ACC operation section 41 includes setting switches for setting various settings of the ACC. A driver can set a target inter-vehicle distance and a target own-vehicle speed, for example, by operating the setting switches. Those switches may be realized by a user interface displayed on a display with a touch screen.

Accelerator-operation detection section 43 detects the depression amount of an accelerator pedal and outputs the detection result to driving assistance apparatus 30. Driving assistance apparatus 30 transmits drive commands to engine ECU 18 and motive power transmission ECU 19 on the basis of the depression amount of the accelerator pedal.

Brake-operation detection section 44 detects the depression amount of a brake pedal for operating service brakes 21. Brake-operation detection section 44 detects whether an auxiliary brake lever that causes retarder 22 or exhaust brake 23 to operate has been operated. Brake-operation detection section 44 outputs the detection result relating to the brake pedal and the auxiliary brake lever to driving assistance apparatus 30. Driving assistance apparatus 30 transmits a braking command to brake ECU 24 on the basis of the depression amount of the brake pedal. Driving assistance apparatus 30 controls the ON/OFF operation of retarder 22 or exhaust brake 23 on the basis of the operation of the auxiliary brake lever.

Driving assistance apparatus 30 outputs various information relating to traveling from information output section 50. For example, information output section 50 outputs sound and display, to thereby indicate that the ACC is being executed or the ACC is being stopped.

<2>Configuration of Driving Assistance Apparatus of Embodiment

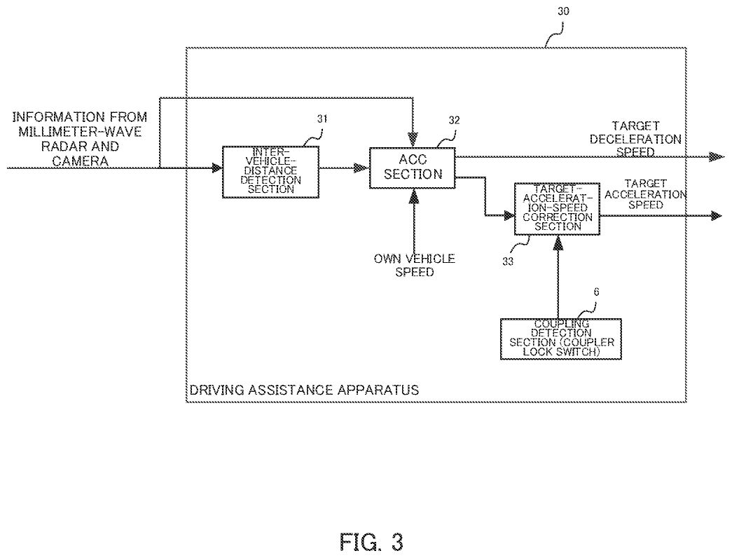

FIG. 3 is a block diagram illustrating the configuration of driving assistance apparatus 30 of the present embodiment.

Driving assistance apparatus 30 has inter-vehicle-distance detection section 31, ACC section 32, target-acceleration-speed correction section 33, and coupling detection section (coupler lock switch) 6.

Inter-vehicle-distance detection section 31 measures (detects) the inter-vehicle distance between own vehicle 1 and a leading car on the basis of information obtained by the millimeter-wave radar, the camera, and the like, and outputs the measurement result to ACC section 32. Inter-vehicle-distance detection section 31 may measure the inter-vehicle distance on the basis of information from other sensors such as a laser radar.

ACC section 32 basically executes known ACC processing. In other words, ACC section 32 outputs a target acceleration speed and a target deceleration speed for causing own car to follow a leading car on the basis of the relative speed and the inter-vehicle distance between the own car and the leading car. As a result, automatic following control is realized. When there are no leading cars, ACC section 32 outputs a target acceleration speed for causing the speed of the own car to be a set certain speed. As a result, constant-speed traveling control is realized.

Automatic-following traveling control is control that operates driving system 10 and braking system 20 such that the inter-vehicle distance is within a predetermined target range and the relative speed approaches zero when a leading vehicle is present in a predetermined range. The constant-speed traveling control is control that operates driving system 10 and braking system 20 such that the traveling speed of vehicle 1 approaches a predetermined target value when there are no leading vehicles in a predetermined range.

The target acceleration speed output from ACC section 32 and the detection result of coupling detection section (coupler lock switch) 6 are input to target-acceleration-speed correction section 33. When the detection result indicating that trailer 2 is coupled is input to target-acceleration-speed correction section 33 from coupling detection section 6, target-acceleration-speed correction section 33 outputs the target acceleration speed output from ACC section 32 as it is without correction. Meanwhile, when the detection result indicating that trailer 2 is not coupled is input to target-acceleration-speed correction section 33 from coupling detection section 6, target-acceleration-speed correction section 33 corrects the target acceleration speed output from ACC section 32 to a small value and outputs the small value. At this time, target-acceleration-speed correction section 33 may perform correction of subtracting a certain fixed value from the target acceleration speed output from ACC section 32 or may perform correction of subtracting a larger value as the target acceleration speed becomes larger, for example.

The target acceleration speed is transmitted to driving system 10, and the target deceleration speed is transmitted to braking system 20.

In engine ECU 18 and motive power transmission ECU 19 of vehicle 1, a table in which the target acceleration speed and the torque and the gear stage number are associated with each other is provided, the torque and the gear stage number corresponding to the target acceleration speed are read out from the table, and transmission control that selects the engine control and the gear stage number for outputting the torque is performed.

In vehicle 1 capable of towing trailer 2, a table set on the premise that the trailer is coupled is provided. In other words, in a situation in which the trailer is coupled, the torque and the gear stage number suitable for realizing the input target acceleration speed can be obtained by referring to the table. This is because, in vehicle 1 capable of towing trailer 2, a state in which the trailer is coupled is a normal state and it is prioritized to obtain a desired acceleration speed in this state.

Conversely, in a situation in which the trailer is not coupled, the torque and the gear stage number obtained by referring to the table may be of values with which an acceleration speed larger than the target acceleration speed is to be generated. As a result, the driving feeling would be degraded in a situation in which the trailer is not coupled.

In view of the above, in the present embodiment, when a detection result indicating that trailer 2 is coupled is input from coupling detection section 6, the target acceleration speed output from ACC section 32 is output as it is without correction. Meanwhile, when a detection result indicating that trailer 2 is not coupled is input from coupling detection section 6, the target acceleration speed output from ACC section 32 is corrected to a small value and the small value is output. As a result, even when the table set on the premise that the trailer is coupled is used, the actual acceleration speed at the time when the trailer is not coupled can be caused to approach the target acceleration speed originally intended by ACC section 32.

### <3>Effects of Embodiment

As described above, according to the present embodiment, when a detection result indicating that trailer 2 is coupled is obtained, the target acceleration speed output from ACC section 32 is output to driving system 10 as it is. Meanwhile, when a detection result indicating that trailer 2 is not coupled is obtained, the target acceleration speed output from ACC section 32 is corrected to a small value and the small value is output to driving system 10.

As a result, driving assistance apparatus 30 that may improve the driving feeling when the ACC is active in vehicle 1 to which trailer 2 can be coupled can be realized.

In the present embodiment, target-acceleration-speed correction section 33 that simply performs a simple subtraction only needs to be provided. Therefore, the driving feeling when the ACC is active can be improved with the addition of a simple configuration as compared to a case where a table for when the trailer is coupled and a table for when the trailer is not coupled are provided, for example.

### <4>Other Embodiment

The abovementioned embodiment is merely an example of a realization for carrying out the present invention, and the interpretation of the technical scope of the present invention is not to be limited by those embodiments. In other words, the present invention can be carried out in various forms without departing from the gist or the main features of the present invention.

In addition to the abovementioned embodiment, braking system 20 capable of performing control that increases the engine brake force by shifting down the gear stage may be further provided, and the control of increasing the engine brake force by shifting down the gear stage may be prohibited when a detection result indicating that trailer 2 is not coupled is obtained by coupling detection section 6.

In this way, unintentional rapid deceleration when trailer 2 is uncoupled and the vehicle weight is light can be suppressed. As a result, the driving feeling also improves at the time of deceleration in addition to the time of acceleration.

The present application is based on Japanese Patent Application (Japanese Patent Application No. 2020-033740) filed on Feb. 28, 2020, the entire content of which is incorporated herein by reference.

### INDUSTRIAL APPLICABILITY

The driving assistance apparatus and the driving assistance method of the present disclosure are suitable for use as a driving assistance apparatus and a driving assistance method that may improve the driving feeling when ACC is active in a vehicle to which a trailer can be coupled.

### REFERENCE SIGNS LIST

1 Vehicle
2 Trailer
3 Vehicle main-body portion
6 Coupling detection section (coupler lock switch)
10 Driving system
11 Engine
12 Clutch
13 Transmission
14 Propeller shaft
15 Differential gear
16 Drive shaft
17 Wheel
18 Engine ECU
19 Motive power transmission ECU
20 Braking system
21 Service brake
22 Retarder
23 Exhaust brake
24 Brake ECU
30 Driving assistance apparatus
31 Inter-vehicle-distance detection section
32 ACC section
33 Target-acceleration-speed correction section
41 ACC operation section
43 Accelerator-operation detection section
44 Brake-operation detection section
50 Information output section

1. A driving assistance apparatus that assists driving of a vehicle to which a trailer is capable of being coupled, the driving assistance apparatus comprising:
an adaptive cruise control (ACC) section that outputs a target acceleration speed for following a leading car or performing constant speed traveling at a set speed;
a coupling detection section that detects whether a trailer is coupled to the vehicle; and
a target-acceleration-speed correction section that outputs the target acceleration speed to a driving system when a detection result indicating that the trailer is coupled is obtained by the coupling detection section and outputs a corrected target acceleration speed obtained by correcting the target acceleration speed to a small value to the driving system when a detection result indicating that the trailer is not coupled is obtained by the coupling detection section.

2. The driving assistance apparatus according to claim 1, further comprising a braking system capable of performing control of increasing an engine brake force by shifting down a gear stage, wherein the control of increasing the engine brake force by shifting down the gear stage is prohibited when the detection result indicating that the trailer is not coupled is obtained by the coupling detection section.

3. A driving assistance method of assisting driving of a vehicle to which a trailer is capable of being coupled, the driving assistance method comprising:
outputting a target acceleration speed for following a leading car or performing constant speed traveling at a set speed;
detecting whether a trailer is coupled to the vehicle; and
outputting the target acceleration speed to a driving system when a detection result indicating that the trailer is coupled is obtained and outputting a corrected target acceleration speed obtained by correcting the target acceleration speed to a small value to the driving system when a detection result indicating that the trailer is not coupled is obtained.
